(19) United States
(12) Patent Application Publication
(10) Pub. No.: US 2025/0373150 A1
(43) Pub. Date: Dec. 4, 2025

(54) METHOD AND APPARATUS FOR PROVIDING SURGE PROTECTION IN A POWER CONVERSION DEVICE

(71) Applicant: Enphase Energy, Inc., Petaluma, CA (US)

(72) Inventors: Sagar Bhanudas NARALE, Maharashtra (IN); Sivanageswararao UDDANTI, Bangalore (IN); Vamshi Krishna MIRYALA, Nalgonda (IN); Shaik CHANDBASHA, Bangalore (IN); Shivam Kumar SRIVASTVA, Gorakhpur (IN)

(21) Appl. No.: 19/215,485

(22) Filed: May 22, 2025

(30) Foreign Application Priority Data
May 28, 2024 (IN) 202411041524

(51) Int. Cl. H02M 1/32; H02M 1/44; H02M 7/797

(52) U.S. Cl. CPC H02M 1/325; H02M 1/44; H02M 7/797

(57) ABSTRACT

Method and apparatus for providing surge protection in a power conversion device. The apparatus comprises a surge protector, coupled to a resonant circuit of a cycloconverter, to bypass a tank current from the resonant circuit away from the cycloconverter when the power conversion device is being shut down.

### RELATED APPLICATION

This application claims benefit to Indian Provisional Patent Application Ser. No. 202411041524 filed 28 May 2024 entitled “Method and Apparatus for Providing Surge Protection in a Power Conversion Device,” which is hereby incorporated herein by reference in its entirety.

### BACKGROUND

### Field

Embodiments of the present invention generally relate to power conversion devices and, in particular, to a method and apparatus for providing surge protection in a power conversion device having bidirectional switches at the AC port.

### Description of the Related Art

High efficiency power conversion devices (e.g., microinverters) used in, for example, solar energy systems comprise a cyclo-converter as part of the circuitry for converting DC power to AC power. In some instances, for example, where the power conversion device is used to charge and discharge a battery, the power conversion device may operate bidirectionally to convert DC power to AC power (battery discharge) and convert AC power to DC power (battery charge).

Unfortunately, the field effect transistors (FETs) used in cyclo-converters are subject to avalanching during shutdown of the power conversion device. As a power conversion device is shutdown, the device may experience a power surge that causes an avalanche condition. Furthermore, these cyclo-converters should also withstand high voltage surges that appear from the AC grid. This makes preventing avalanching MOSFETs in cycloconverter much more challenging. Such an avalanche condition can damage the circuitry and render the power conversion device inoperative.

Therefore, there is a need for a method and apparatus for providing surge protection in a power conversion device.

### SUMMARY

A method and apparatus for providing surge protection in a power conversion device is provided substantially as shown in and/or described in connection with at least one of the figures, as set forth more completely in the claims.

Various features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the various features of the present invention can be understood in detail, a particular description of the invention, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of a power conversion device in accordance with at least one embodiment of the invention;

FIG. 2 depicts a schematic diagram of an AC circuit of FIG. 1 comprising a surge protector in accordance with at least one embodiment of the invention; and

FIG. 3 depicts a schematic diagram of an AC circuit of FIG. 1 comprising an alternative surge protector in accordance with at least one embodiment of the invention.

### DETAILED DESCRIPTION

Embodiments of the present invention comprise apparatus and methods for providing surge protection in a power conversion device. Embodiments include a power conversion device having a DC bridge circuit, a transformer and an AC bridge circuit in the form of a cyclo-converter. The cyclo-converter comprises an AC bridge circuit, a resonant circuit and AC filter capacitors. Within the cyclo-converter, a surge protector is connected between a bridge circuit and the AC filter capacitors. In one embodiment, the surge protector comprises a series connected pair of field effect transistors (FETs) that are turned on (conducting) when the FETs of the cycloconverter are turned off in a power conversion device shutdown. The surge protector provides a bypass path for the transformer tank current to flow through and avoid causing the bridge FETs experiencing avalanche.

In one embodiment, a drive circuit controls the operation of the surge protector. The drive circuit may locally monitor operation of the cyclo-converter (e.g., monitor output AC voltage of the power conversion device) and turn on the surge protector when the output voltage rises above a threshold indicating the power conversion device is being turned off. When this occurs, the controller activates the surge protector while turning off the power conversion device.

In an alternative embodiment, a Si-Dactor circuit may be used instead of the pair of FETs. This circuit is self-powered and self-activated through monitoring the voltage across the surge protector. When the voltage across the surge protector rises above a threshold level, the surge protector activates without using a control signal from an external controller.

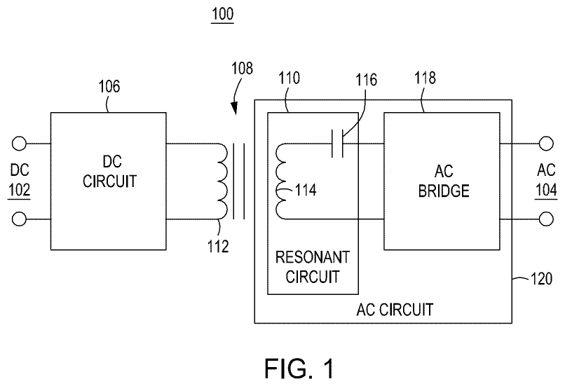

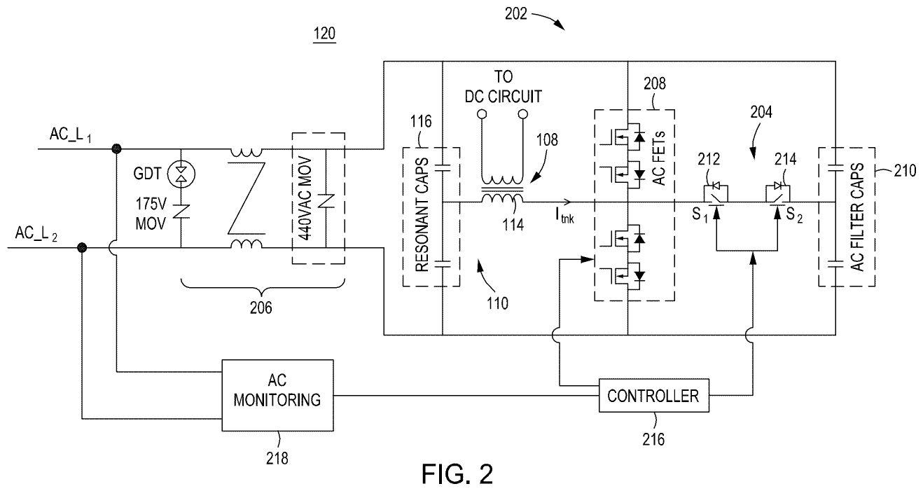

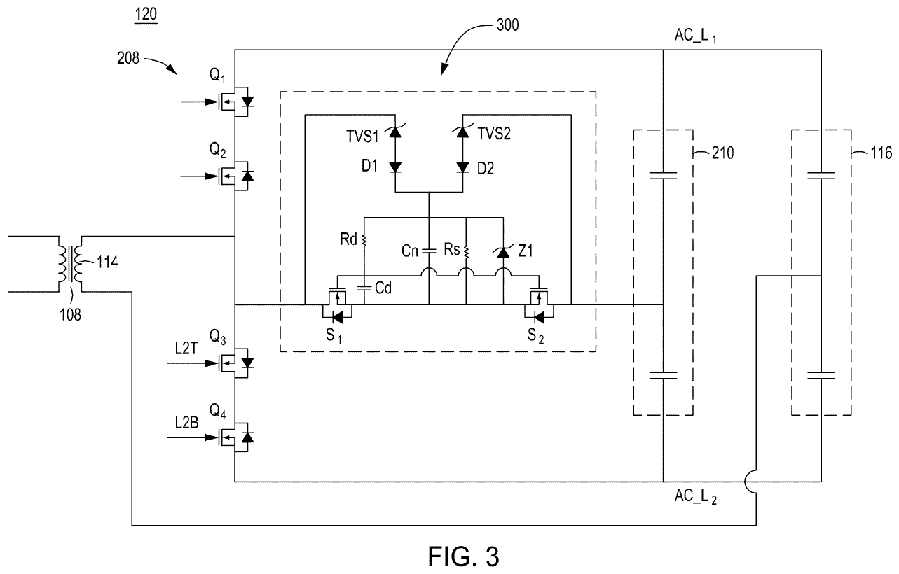

FIG. 1 depicts a block diagram of a power conversion device 100 in accordance with at least one embodiment of the invention. In a power conversion device 100 that operates in a bidirectional manner converts DC power 102 to AC power 104 and vice versa. The power conversion device 100 comprises a DC circuit 106, a transformer 108, and an AC circuit 120. The AC circuit 120 comprises resonant circuit 110 and an AC bridge 118. The transformer 108 has a primary winding 112 and a secondary winding 114, where the secondary winding 114 and at least one capacitor 116 form the resonant circuit 110. In one embodiment, as described in detail with respect to FIGS. 2 and 3, the AC bridge 118 comprises a cycloconverter having a surge protector in accordance with at least one embodiment of the invention.

FIG. 2 depicts a schematic diagram of the AC circuit 120 of FIG. 1 comprising a surge protector 204 and 206 in accordance with at least one embodiment of the invention. The AC circuit 120 comprises surge protectors 204 and 206, a resonant circuit 110, a transformer 108, and a cycloconverter 202. The cycloconverter 202 comprises FETs 208 and AC filter capacitors 210 (e.g., two capacitors connected in series across the series connected FETs 208). The resonant circuit 110 comprises series connected resonant capacitors 116 coupled across the FETs 208. The connection point of the two resonant capacitors 116 is connected to a first terminal of the transformer winding 114. A second terminal of the transformer winding 114 is connected to the connection point of the series connect FETs 208. The winding 114 and the resonant capacitors 116 form the resonant circuit 110 that is used by the cycloconverter 202.

The surge protector 204 comprises two series connected FETs 212 and 214 that are connected to the second terminal of the transformer winding 114 and connected to the junction point of the series connected filter capacitors 210. When the surge protector is “off”, i.e., not conducting, the cycloconverter 202 operates normally. During a surge event, the surge protector 204 is “on”, i.e., conducting, the FETs 212 and 214 bypass the tank current (link) from the cycloconverter FETs 208 to the filter capacitors 210. Thus, protecting the FETs 208 from avalanche.

In one embodiment, operation of the surge protector 204 is controlled by a controller 216 (e.g., a microcontroller coupled to the FET gates thru a pulse transformer). An AC monitoring circuit 218 monitors the AC voltage. When the AC voltage rises above a defined threshold, the controller 216 turns off the FETs 208 (e.g., when the power conversion device 200 is being shutdown) and turns on the surge protector 204 to cause the tank current to bypass the FETs 208.

In this manner, the FETs 208 are protected from avalanche at shutdown. Consequently, the cycloconverter shutdown may be instantaneous when the power converter device is to be shutdown. Furthermore, the cycloconverter may utilize FETs that have zero avalanche energy such as GaN FETs. Also, by using the surge protector, the power conversion device is more immune to neutral lifting.

FIG. 3 depicts a schematic diagram of an AC circuit 120 of FIG. 1 comprising an alternative surge protector 300 in accordance with at least one embodiment of the invention. In this alternative embodiment, the surge protector 300 is in the form of a Si-Dactor circuit. The surge protector 300 is connected between the second terminal of the transformer winding 114 and the junction point of the filter capacitors 210. The Si-dactor circuit is self-activating, i.e., it does not require an external triggering signal from a controller.

The surge protector 300 comprises transient voltage suppression (TVS) diodes that are used to detect the voltage threshold (TVS1, TVS2). Diodes D1, D2 rectify the power voltage and self-power the driving circuit. Resistor Rd and capacitor Ch are used to filter ringing generated during normal switching transients. Capacitor Cd is used to drive the gate of the FETs S1 and S2. Resistor Rb establishes the duration that S1 and S2 FETs remain in an ON state (i.e., conducting) once they are triggered. Consequently, when the voltage across the surge protector rises to a level above the TVS1 and TVS2 threshold voltages, the surge protector 300 self-activates and shunts the tank current to the filter capacitors 210.

Here multiple examples have been given to illustrate various features and are not intended to be so limiting. Any one or more of the features may not be limited to the particular examples presented herein, regardless of any order, combination, or connections described. In fact, it should be understood that any combination of the features and/or elements described by way of example above are contemplated, including any variation or modification which is not enumerated, but capable of achieving the same. Unless otherwise stated, any one or more of the features may be combined in any order.

As above, figures are presented herein for illustrative purposes and are not meant to impose any structural limitations, unless otherwise specified. Various modifications to any of the structures shown in the figures are contemplated to be within the scope of the invention presented herein. The invention is not intended to be limited to any scope of claim language.

Where “coupling” or “connection” is used, unless otherwise specified, no limitation is implied that the coupling or connection be restricted to a physical coupling or connection and, instead, should be read to include communicative couplings, including wireless transmissions and protocols.

Where conditional language is used, including, but not limited to, “can,” “could,” “may” or “might,” it should be understood that the associated features or elements are not required. As such, where conditional language is used, the elements and/or features should be understood as being optionally present in at least some examples, and not necessarily conditioned upon anything, unless otherwise specified.

Where lists are enumerated in the alternative or conjunctive (e.g., one or more of A, B, and/or C), unless stated otherwise, it is understood to include one or more of each element, including any one or more combinations of any number of the enumerated elements (e.g., A, AB, AC, ABC, ABB, etc.). When “and/or” is used, it should be understood that the elements may be joined in the alternative or conjunctive.

While the foregoing is directed to embodiments of the present invention, other and further embodiments of the invention may be devised without departing from the basic scope thereof, and the scope thereof is determined by the claims that follow.

1. Apparatus for providing surge protection in a power conversion device comprising:
a surge protector, coupled to a resonant circuit of a cycloconverter, to bypass a tank current from the resonant circuit away from the cycloconverter when the power conversion device is being shut down.

2. The apparatus of claim 1 wherein the surge protector comprises a pair of series connected transistors.

3. The apparatus of claim 1 further comprising an AC monitoring circuit for determining the occurrence of a voltage surge.

4. The apparatus of claim 3 further comprising a controller, coupled to the AC monitoring circuit, to activate the surge protector up detection of a voltage surge.

5. The apparatus of claim 1 wherein the surge protector comprises a Si-Dactor circuit.

6. The apparatus of claim 5 wherein the Si-Dactor circuit is self-powered and self-activated upon the occurrence of a voltage surge.

7. The apparatus of claim 6 wherein the Si-Dactor circuit further comprises a pair of transient voltage suppression diodes for establishing a voltage threshold and detecting when a voltage surge is occurring that is greater than the voltage threshold.

8. A method of providing surge protection in a power conversion device, where the power conversion device comprises a cycloconverter, the method comprising:
upon detecting the power conversion device is being shut down, establishing a bypass path for tank current in a resonant circuit to bypass the cycloconverter.

9. The method of claim 8 wherein detecting comprises determining the occurrence of a voltage surge that is indicative of the power conversion device being shut down.

10. The method of claim 8 wherein the bypass path is provided by activating a surge protector comprising a pair of series connected transistors.

11. The method of claim 8 further comprising using an AC monitoring circuit to determine the occurrence of a voltage surge.

12. The method of claim 11 further comprising using a controller, coupled to the AC monitoring circuit, to activate the surge protector upon detection of a voltage surge.

13. The method of claim 8 providing a self-powered Si-Dactor circuit and, upon the occurrence of a voltage surge, self-activating the Si-Dactor circuit to create the bypass path.

14. The method of claim 13 further comprising establishing a voltage threshold using a pair of transient voltage suppression diodes and detecting when the voltage surge is occurring that is greater than the voltage threshold.

15. Apparatus for providing surge protection in a power conversion device comprising:
a surge protector, coupled to a resonant circuit of a cycloconverter, to selectively bypass a tank current from the resonant circuit away from the cycloconverter when a surge voltage is detected that is indicative of the power conversion device being shut down.

16. The apparatus of claim 15 wherein the surge protector comprises a pair of series connected transistors.

17. The apparatus of claim 16 further comprising an AC monitoring circuit for determining the occurrence of the voltage surge and a controller, coupled to the AC monitoring circuit, to activate the surge protector up detection of a voltage surge.

18. The apparatus of claim 15 wherein the surge protector comprises a Si-Dactor circuit.

19. The apparatus of claim 18 wherein the Si-Dactor circuit is self-powered and self-activated upon the occurrence of a voltage surge.

20. The apparatus of claim 19 wherein the Si-Dactor circuit further comprises a pair of transient voltage suppression diodes for establishing a voltage threshold and detecting when the voltage surge is occurring that is greater than the voltage threshold.
